(19) United States
(12) Patent Application Publication
(10) Pub. No.: US 2017/0002246 A1
(43) Pub. Date: Jan. 5, 2017

(54) HEAT TRANSFER FLUIDS COMPOSITIONS

(71) Applicant: SIGMA ENERGY STORAGE INC., Saint-Bruno-de-Montarville (CA)

(72) Inventor: Abdelfettah BANNARI, Sherbrooke (CA)

(21) Appl. No.: 15/268,876

(22) Filed: Sep. 19, 2016

Related U.S. Application Data
(63) Continuation of application No. PCT/CA2015/050227, filed on Mar. 24, 2015.
(60) Provisional application No. 61/969,291, filed on Mar. 24, 2014.

(51) Int. Cl. C09K 5/06; F28D 20/00

(52) U.S. Cl. CPC C09K 5/063; F28D 20/0034; F28D 2020/0047

(57) ABSTRACT

There is provided heat transfer fluids comprising at least one organic fluid, such as an oil and at least one phase change material such as a molten salt that exhibit advantageous heat storage capacities and viscosity properties for heat transfer in such systems as compressed air energy storage systems.

This application claims priority of US provisional patent application No. 61/969,291, filed on Mar. 24, 2014.

### TECHNICAL FIELD

This invention relates generally to heat transfer fluids. More specifically, this invention relates to novel compositions of heat transfer fluids and methods for preparing same.

### BACKGROUND

There are many energy generating and energy-storing systems that require heat transfer materials as a means to exchange heat between two media and to store the recovered energy. Systems such as concentrated solar power, compressed air energy storage and geothermal sources are a few examples.

Thermal energy storage materials are well known in the art and are classified as phase change materials (PCM) and sensible heat storage materials (SHS). PCM's are also known as latent heat storage materials and are capable of storing an amount of energy at least equal to the enthalpy change associated with the phase transition while maintaining a constant temperature. SHS are materials in which heat exchange results in temperature change only (no phase transition).

PCM's have a storable energy density that is greater than that of SHS by roughly an order of magnitude. The most common PCM's are water, diathermic oils and molten salts. While PCM's have a high heat storage capacity at the phase transition they exhibit poor sensible heat storage efficiency outside this relatively narrow temperature range which implies the need to use large amounts in order to achieve desired heat storage capacity when not used at temperatures spanning the phase transition temperature and, consequently, the need to use very large containers for heat exchange that are not suitable for some applications as well as having a high cost. PCM's such as molten salts further have the disadvantage of being in the solid state below the phase transition temperature that cause a prohibitive increase in viscosity where fluidity of the heat transfer fluid is important.

PCM's used for storing thermal energy can be comprised of organic or inorganic mixtures, capable of operating at different temperatures depending on the requirements of the conditions for thermal recovery. Paraffin or mixtures of different molecular weight polyethylene used as materials for PCM systems are already on the market. Similarly SHS are also known and in used for various heat storage applications. However SHS, as mentioned above, are not as efficient as PCM's for storing heat.

Oils are frequently used as HTF/SHS but they often exhibit chemical stability problems at elevated temperatures together with relatively low heat capacities.

PCM's and SHS also present problems, such as viscosity, that are dependant on the environmental temperatures at which a heat exchange system operates. For example for systems used in extremely cold temperatures (below 0° C.) the need to increase the temperature of the fluid before reaching phase transition temperature are typical problems of the prior art.

Document U.S. Pat. No. 6,627,106 describes a ternary mixture of inorganic salts for storing thermal energy as latent heat, due to the phase transition. The ternary mixture, containing nitric acid salts, in particular of magnesium nitrate hexahydrate, lithium nitrate and sodium nitrate or potassium, can work at temperatures between a limited range of 60° C. and 70° C. depending on the percentages of the components. Mixtures of this type are problematic when the temperature is still below the temperature of the phase change tending to separate into zones of different compositions, with consequent variations of the fluidity/viscosity and reducing the heat storage capacity.

Several molten salts heat transfer fluids have been used for solar thermal systems. A binary solar salt mixture was used at the 10 MWe Solar Two central receiver projects in Barstow, CA. It will also be used in the indirect TES system for the Andasol plant in Spain. Among the candidate mixtures, molten salts have the highest thermal stability and the lowest cost, but also the highest melting point. The binary salt referred to above is thermally stable at temperatures up to 454° C., and may be used up to 538° C. for short periods, but a nitrogen cover gas is required to prevent the slow conversion of the nitrite component to nitrate. However, the currently available molten salt formulations do not provide an optimum combination of properties such as freezing point and cost that are needed for a replacement heat transfer fluid in parabolic trough solar fields.

Documents U.S. Pat. No. 8,387,374 B2, U.S. Pat. No. 8,474,255 B2 and U.S. Pat. No. 8,454,321 B2 respectively owned by lightsail Energy Inc., SustainX Inc. and General Compression Inc. use water in their thermal recoveries. This recovery is limited by the phase change of water, which limits the heat recovery, which is controlled by the temperature of phase change of water at 100° C. The operation conditions of the CAES-A G developed by these companies is a kind of quasi-isothermal regime, which limits the operating pressure and the flow rate of compression.

The problems mentioned above can be reduced, but not completely eliminated, because they are caused by the intrinsic properties of the mixtures. While certain mixtures have proved satisfactory in laboratory tests they are often not suitable for use on an industrial scale because of problems of stability for example. There are certain blends that work particularly well at high temperatures, above 250° C. as the lower limit, and are used in combination with turbines and solar concentrators. They are useful if maximization of power production is desired, but they cannot be used at low temperatures.

Basically thermal energy storage compositions (heat transfer fluids) disclosed in the prior art are still unable to provide economically advantageous, optimal physico-chemical properties in many of the conditions where heat exchange is needed for the recovery and use of energy. Therefore better heat transfer fluids are desirable.

### SUMMARY

There is provided heat transfer fluids comprising at least one organic fluid, such as an oil and at least one PCM such as a molten salt that exhibit advantageous heat storage capacities and viscosity properties. For example, the mixtures of oil and salts of the invention allow a greater amount of heat to be transferred, transported and stored in the fluid than if it would be only comprised of oil. The oil provides advantageous viscosity characteristics that are imparted to the mixture. Therefore it is possible to greatly reduce the quantity and the costs of the thermal transfer fluid for a given system or application.

There is also provided a method for exchanging heat energy in a heat transfer system comprising selecting a heat transfer fluid comprising at least one PCM in an organic fluid and having a heat capacity profile as a function of temperature and contacting the fluid with a heat exchange surface to allow heat to be conducted through the organic fluid to the at least one PCM. The selection of the heat transfer fluid may comprise matching the heat capacity profile of the heat transfer fluid to the heat transfer system energy storage requirement.

The heat transfer fluid exhibit physico-chemical properties that can be advantageously exploited in compressed air energy storage (CAES) systems.

### BRIEF DESCRIPTION OF THE DRAWINGS

The invention will be better understood by way of the following detailed description of embodiments of the invention with reference to the appended drawings, in which:

FIG. 1 is a schematic representation of a heat fluid of the present invention in a heat exchange system.

FIG. 2 A is Differential Scanning calorimetry (Cₚ) plot of heat exchange fluid A1.

FIG. 2B is a derivative of the DSC (dCₚ/dT) plot of A1.

FIG. 2C shows the area under the DSC curve corresponding to the integral of Cp.

FIG. 3 A is Differential Scanning calorimetry (Cₚ) plot of heat exchange fluid A2.

FIG. 3B is a derivative of the DSC (dCₚ/dT) plot of A2.

FIG. 3C shows the area under the DSC curve corresponding to the integral of Cp.

FIG. 4 A is Differential Scanning calorimetry (Cₚ) plot of heat exchange fluid A3.

FIG. 4B is a derivative of the DSC (dCₚ/dT) plot of A3.

FIG. 4C shows the area under the DSC curve corresponding to the integral of Cp.

FIG. 5 A is Differential Scanning calorimetry (Cₚ) plot of heat exchange fluid A4.

FIG. 5B is a derivative of the DSC (dCₚ/dT) plot of A4.

FIG. 5C shows the area under the DSC curve corresponding to the integral of Cp.

FIG. 6 A is Differential Scanning calorimetry (Cₚ) plot of heat exchange fluid A5.

FIG. 6B is a derivative of the DSC (dCₚ/dT) plot of A5.

FIG. 6C shows the area under the DSC curve corresponding to the integral of Cp.

FIG. 7 A is Differential Scanning calorimetry (Cₚ) plot of heat exchange fluid A6.

FIG. 7B is a derivative of the DSC (dCₚ/dT) plot of A6.

FIG. 7C shows the area under the DSC curve corresponding to the integral of Cp.

FIG. 8A is Differential Scanning calorimetry (Cₚ) plot of heat exchange fluid A7.

FIG. 8B is a derivative of the DSC (dCₚ/dT) plot of A7.

FIG. 8C shows the area under the DSC curve corresponding to the integral of Cp.

FIG. 9A is Differential Scanning calorimetry (Cₚ) plot of heat exchange fluid A8.

FIG. 9B is a derivative of the DSC (dCₚ/dT) plot of A8.

FIG. 9C shows the area under the DSC curve corresponding to the integral of Cp.

FIG. 10 A is Differential Scanning calorimetry (Cₚ) plot of heat exchange fluid B1.

FIG. 10B is a derivative of the DSC (dCₚ/dT) plot of B1.

FIG. 10C shows the area under the DSC curve corresponding to the integral of Cp.

FIG. 11 A is Differential Scanning calorimetry (Cₚ) plot of heat exchange fluid B2.

FIG. 11B is a derivative of the DSC (dCₚ/dT) plot of B2.

FIG. 11C shows the area under the DSC curve corresponding to the integral of Cp.

FIG. 12 A is Differential Scanning calorimetry (Cₚ) plot of heat exchange fluid B3.

FIG. 12B is a derivative of the DSC (dCₚ/dT) plot of B3.

FIG. 12C shows the area under the DSC curve corresponding to the integral of Cp.

FIG. 13 A is Differential Scanning calorimetry (Cₚ) plot of heat exchange fluid B4.

FIG. 13B is a derivative of the DSC (dCₚ/dT) plot of B4.

FIG. 13C shows the area under the DSC curve corresponding to the integral of Cp.

FIG. 14 A is Differential Scanning calorimetry (Cₚ) plot of heat exchange fluid B5.

FIG. 14B is a derivative of the DSC (dCₚ/dT) plot of B5.

FIG. 14C shows the area under the DSC curve corresponding to the integral of Cp.

FIG. 15 A is Differential Scanning calorimetry (Cₚ) plot of heat exchange fluid B6.

FIG. 15B is a derivative of the DSC (dCₚ/dT) plot of B6.

FIG. 15C shows the area under the DSC curve corresponding to the integral of Cp.

FIG. 16 A is Differential Scanning calorimetry (Cₚ) plot of heat exchange fluid B7.

FIG. 16B is a derivative of the DSC (dCₚ/dT) plot of B7.

FIG. 16C shows the area under the DSC curve corresponding to the integral of Cp.

### DETAILED DESCRIPTION

By “fluid” it is meant a liquid, an emulsion, a slurry, and/or a stream of solid particles that has flow characteristics similar to liquid flow.

By “heat stability” it is meant that a chemical, for example an oil, is not chemically degraded up to a predetermined or specified temperature.

By “liquidus temperature” it is meant the temperature at which crystals of a material (for example molten salts) can co-exist with the melt. Above the liquidus temperature the material is homogeneous and liquid. Below the liquidus temperature the material crystallizes and more and more crystals are formed up to forming a completely crystallized or solidified material (solidus temperature).

By “mass fraction” it is meant the mass of a particular component of a mixture divided by the mass of the total composition comprising the component.

In one aspect of the invention there is provided new binary heat transfer fluids comprising one or more Phase Change Material PCM and one or more organic fluid. The heat transfer fluids of the present invention possess physico-chemical properties enabling rapid and efficient heat transfer and storage over a wide range of temperatures and pressures conditions. Furthermore these novel fluids also enable the design of a heat capacity profile as a function of temperature to optimize heat storage based on their heat capacity characteristics.

In a preferred embodiment the PCM of the heat transfer fluid comprises one or more molten salts. It has been discovered by the inventors that the combination of PCM's such as salts with organic fluids, such as oils, provides mixtures that can retain the advantageous characteristics of both while avoiding some of the disadvantages. Heat transfer fluids of the present invention advantageously combine sensible heat storage, latent heat storage and viscosity characteristics enabling operation over a broad range of temperatures and with a diversity of heat exchange systems.

For example, it has been discovered by the inventors that when molten salts are mixed with organic fluids, such as oils, the mixtures exhibit phase transitions that are similar, although not necessarily identical, to the phase transitions of the salts alone and permits the establishment of a heat capacity profile as a function of temperature that can be tailored to optimize heat storage and transfer in a variety of heat transfer systems. Furthermore the viscosity of the mixtures is similar, though not identical, to the viscosity of the oil(s) alone. The mixtures are therefore usable at low ambient (environmental) temperatures because the viscosity of oils is low and compatible with fluid circulation in conduits in a range of temperature encompassing, in certain cases, sub-zero degree Celsius temperatures. Yet because of their high thermal stability the heat transfer fluids of the invention can also be used to exchange heat in systems operating at very high temperatures.

The organic fluid component of the heat transfer fluids of the invention may consist of an oil, or two or more oils, incorporated in a binary heat transfer fluid (oil and salts for example) at a predetermined mass ratio. The choice of the oil (or oils) is dictated by the desired physico-chemical characteristics of the oil-molten salts mixture which in turn are dictated by the conditions of operation of the heat transfer unit.

Suitable oil, or mixture of oils, may consist, for example, of synthetic oils or silicone oils. The synthetic oil can be selected, for example, from biphenyl, biphenyl oxide, diphenyl oxide, di and tri-aryl ethers, diphenylethane, alkylbenzenes, diaryl alkyls cyclohexanes, terphenyls and combination thereof. Silicone oil, which is any liquid polymerized siloxane with organic side chains, can be selected, for example, from polymethoxy phenyl siloxane, dimethyl polysiloxane and combination thereof.

The molten salts component of the heat transfer fluids of the invention can be any salt having heat transfer and heat capacity (Cᵣ) characteristics compatible with the heat transfer system in which they are used. In a preferred embodiment the heat transfer fluids of the present invention comprise nitrate salts preferably selected from nitric acid salt, nitric oxide salt and combination thereof. The nitrate salts can be selected from Ba, Be, Sr, Na, Ca, Li, K, Mg nitrate salts in preferred embodiments the salts are selected from Mg-nitrate (Mg(NO₃)₂), K-nitrate (KNO₃), Na-nitrate (NaNO₃), Li-nitrate (LiNO₃), Ca-nitrate (Ca(NO₃)₂), K-nitrite (KNO₂), Na-nitrite (NaNO₂), Li-nitrite (LiNO₂), Ca-nitrite (Ca(NO₂)₂) salts and combination thereof. The molten salt(s) component in the heat transfer fluids of the invention can be a single salt, a binary salt, ternary or quaternary (i.e. combinations of salts) mixture. These salts exhibit high temperature stability as will be exemplified below. In a preferred embodiment, the nitrate salts are monovalent (K-nitrate (KNO₃), Na-nitrate (NaNO₃), Li-nitrate (LiNO₃)).

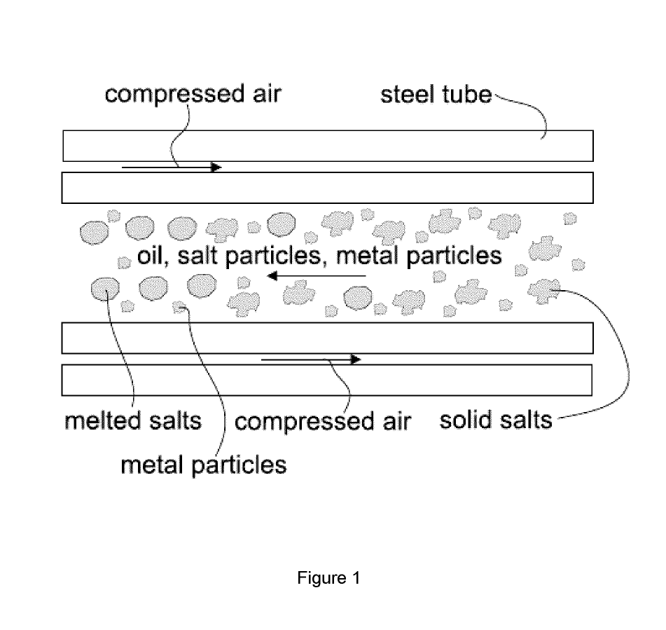

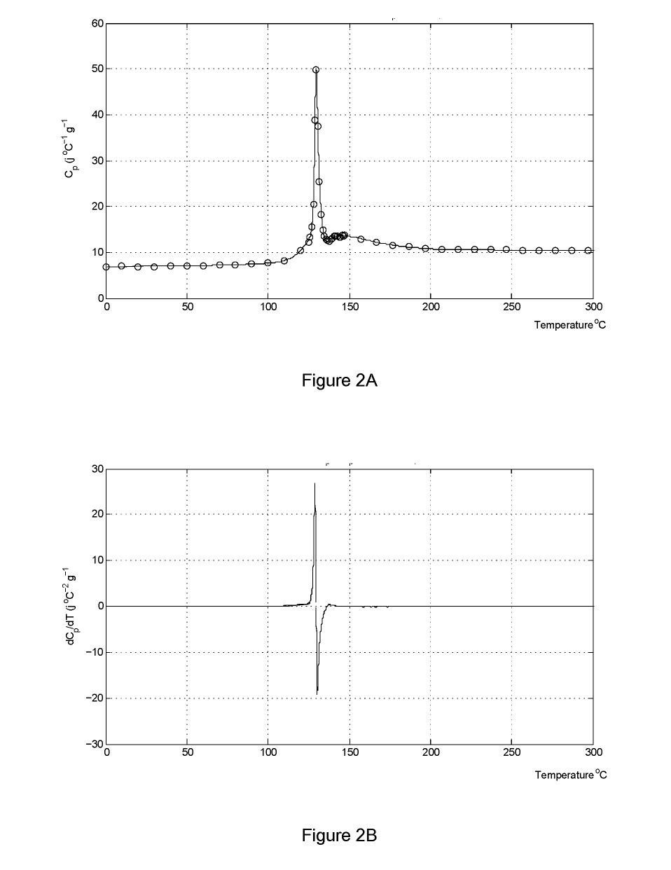

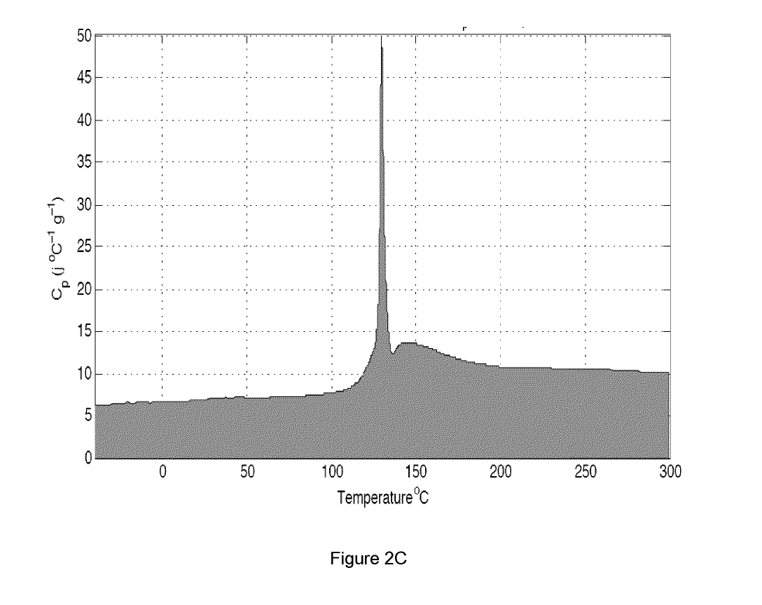

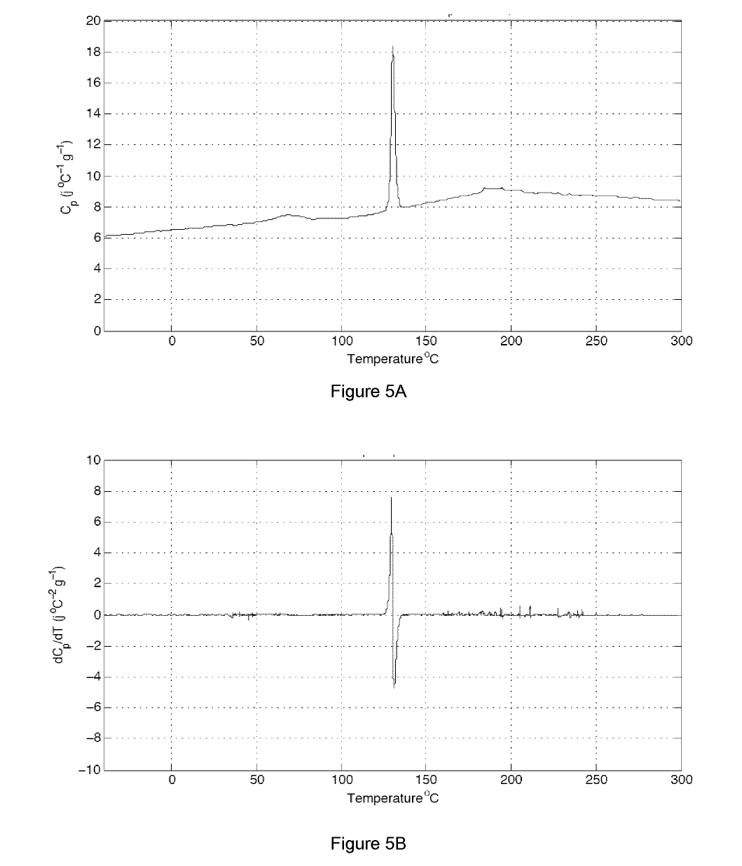

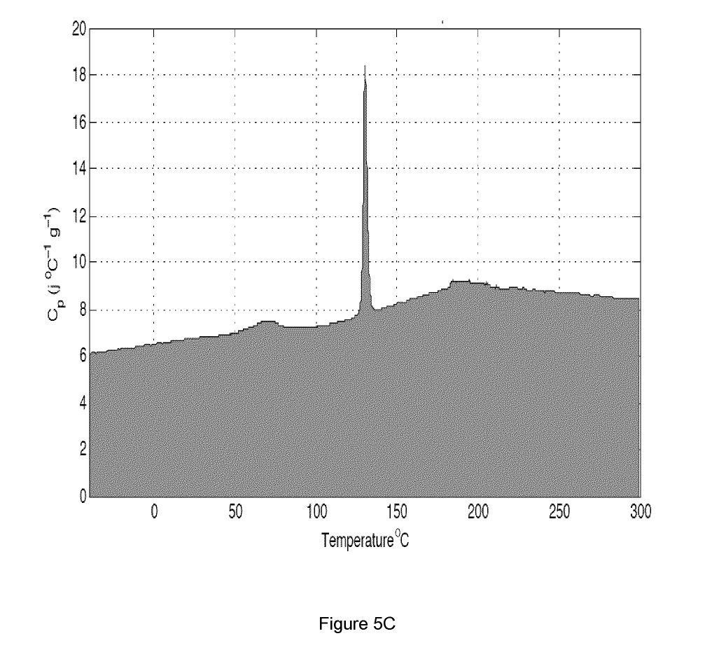

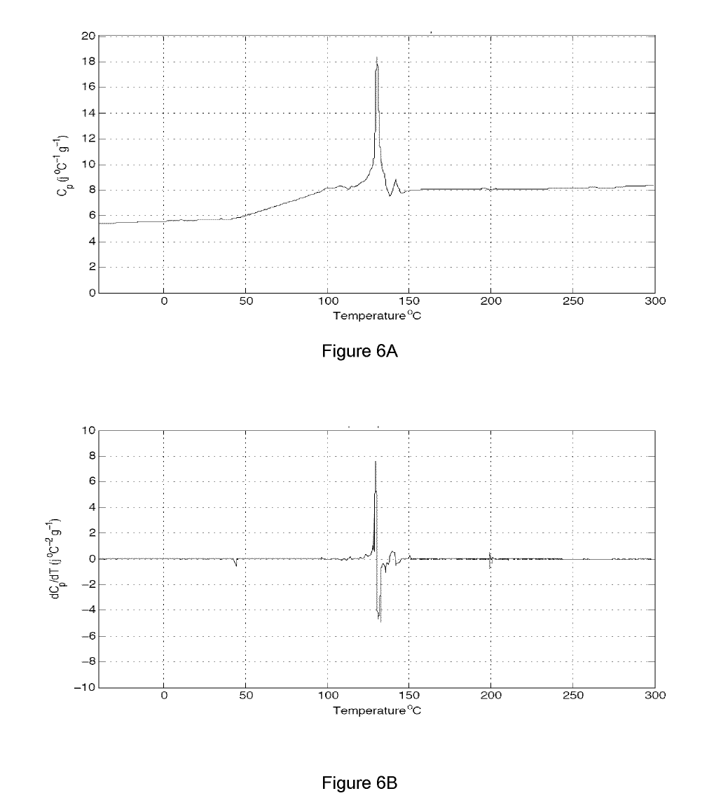

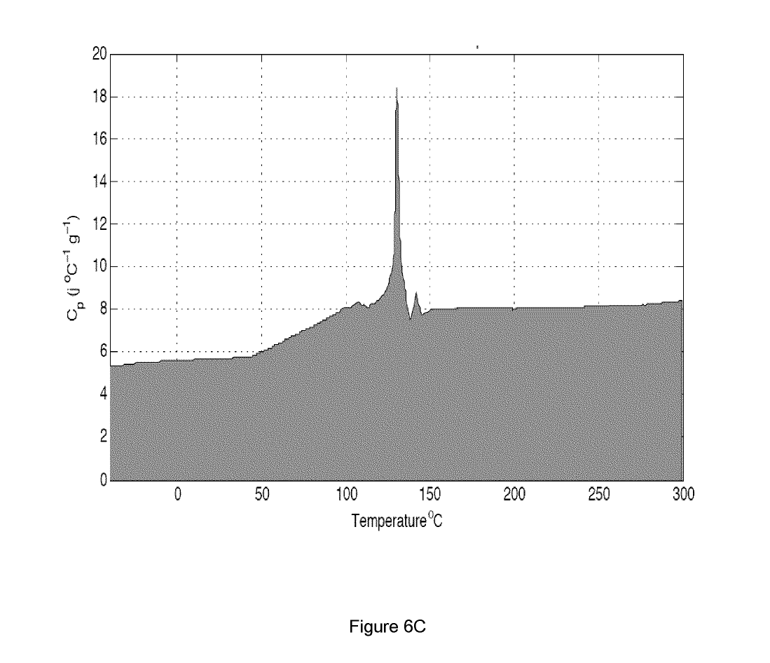

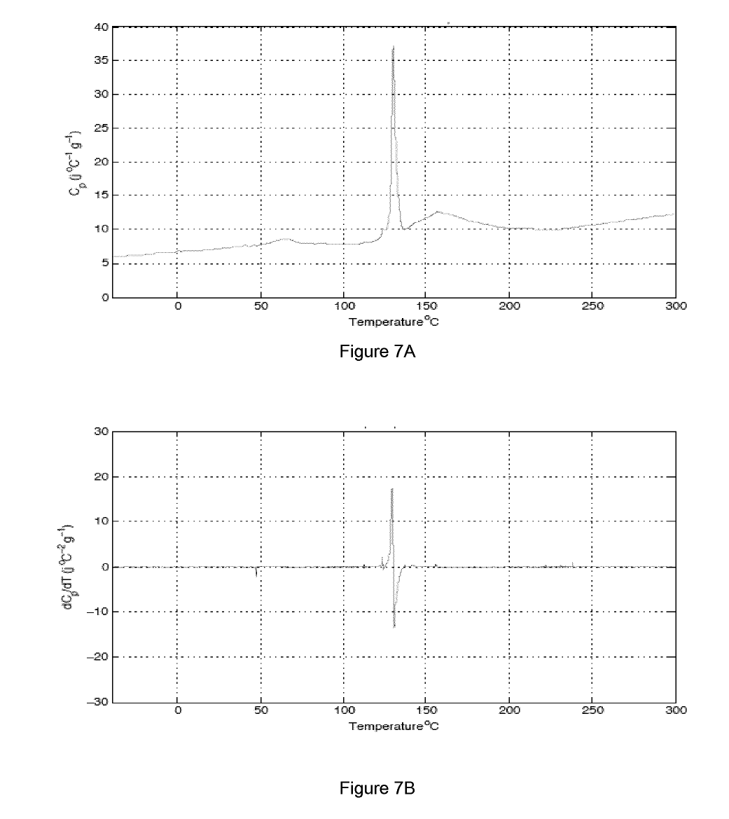

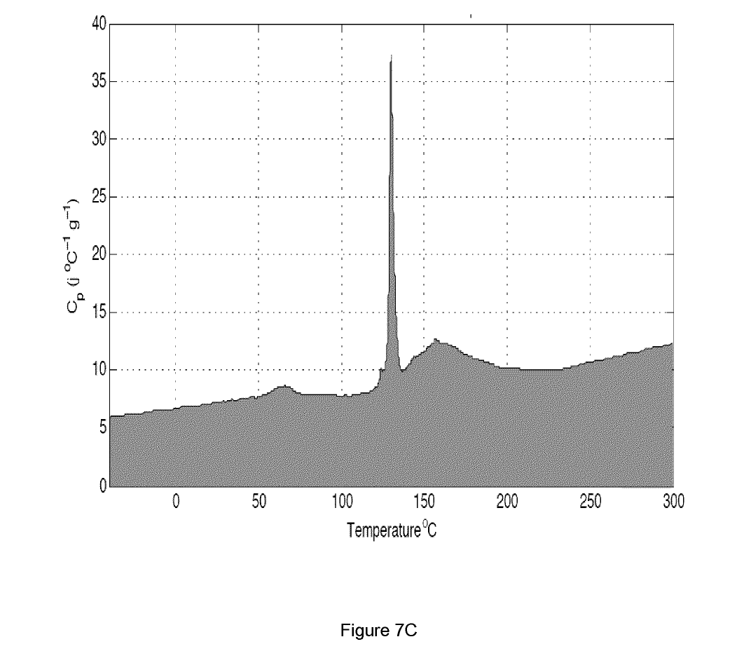

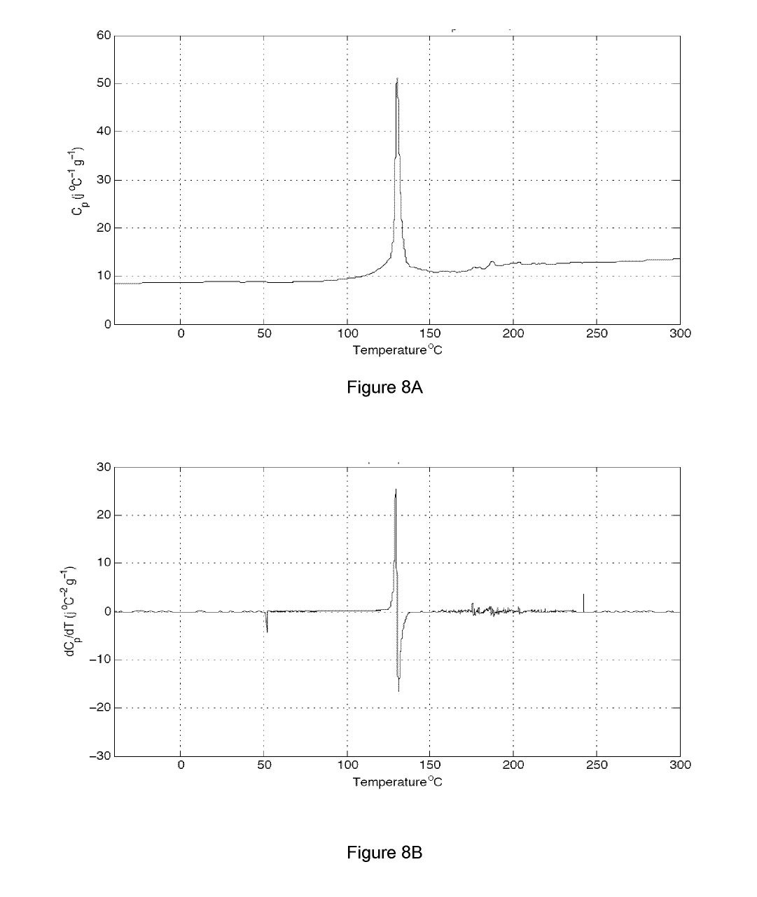

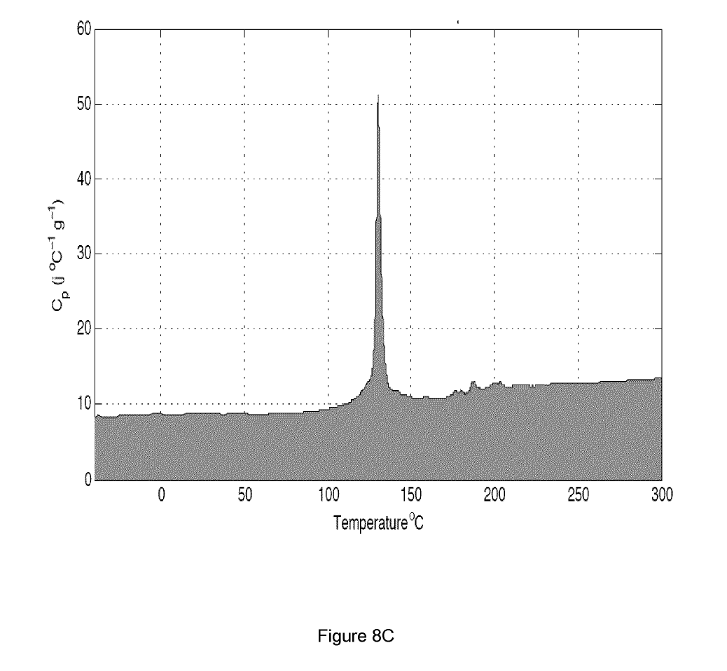

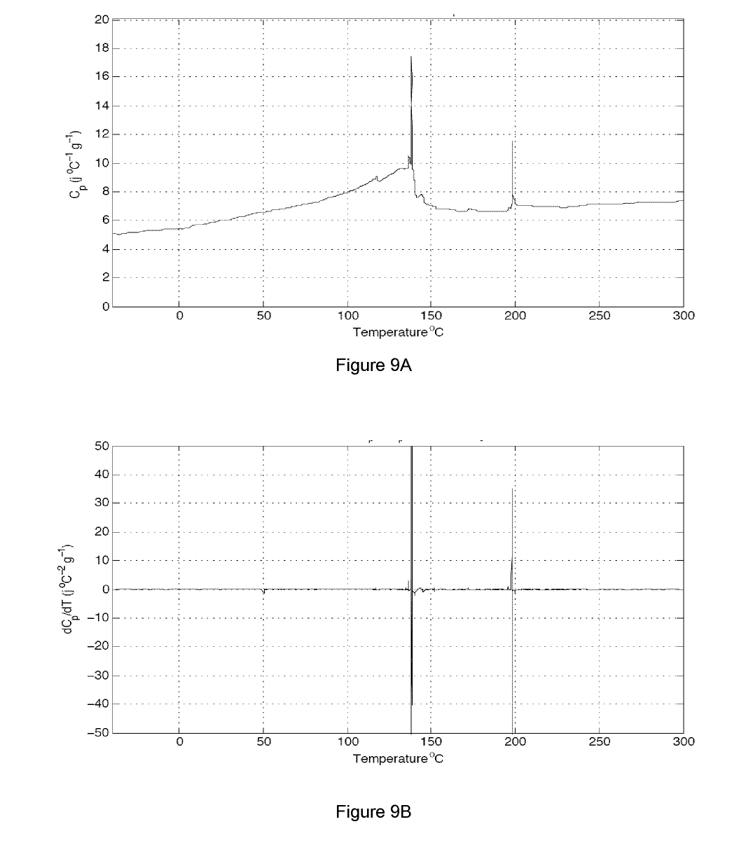

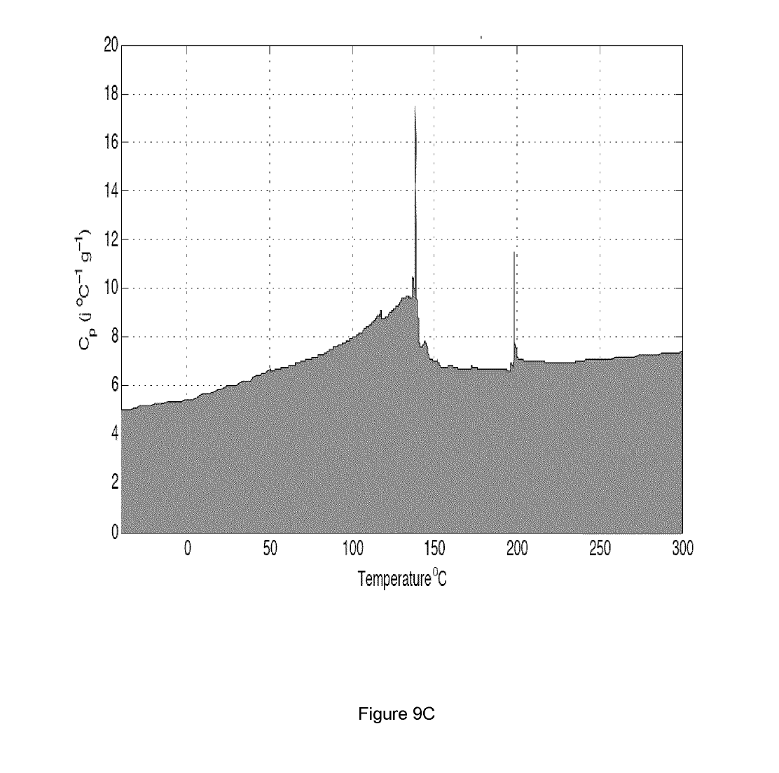

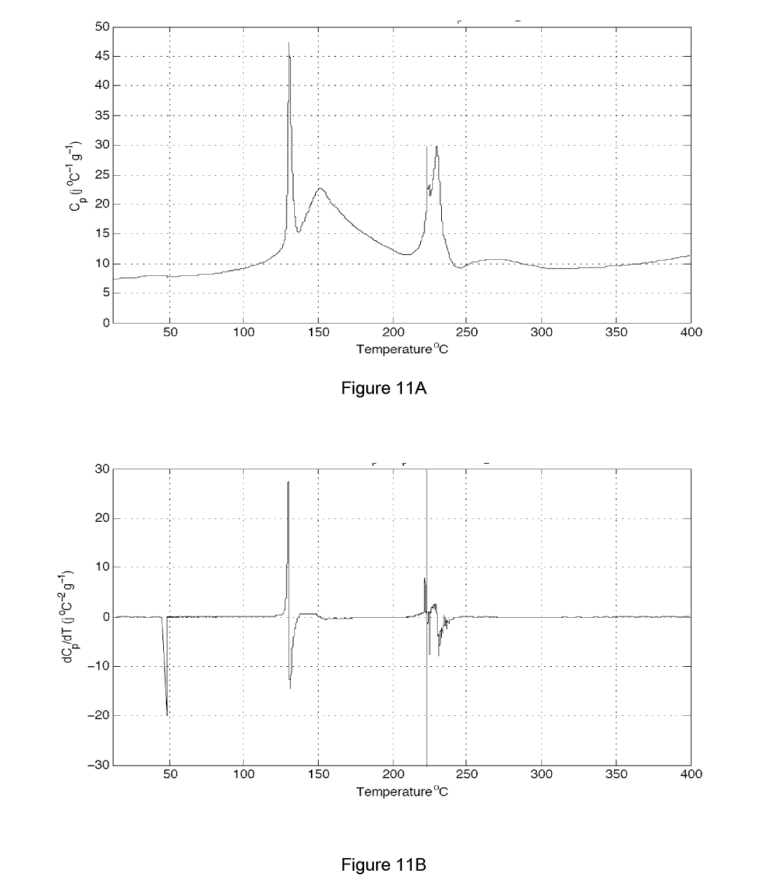

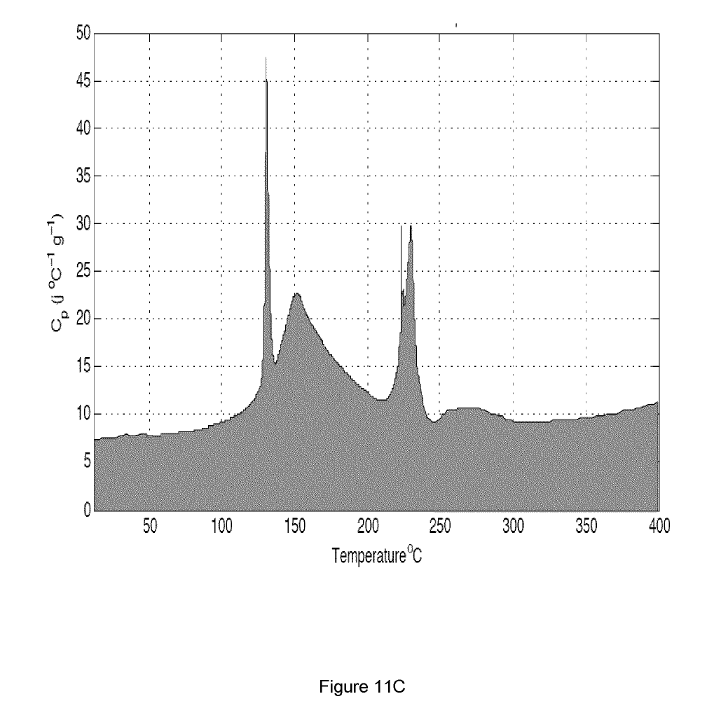

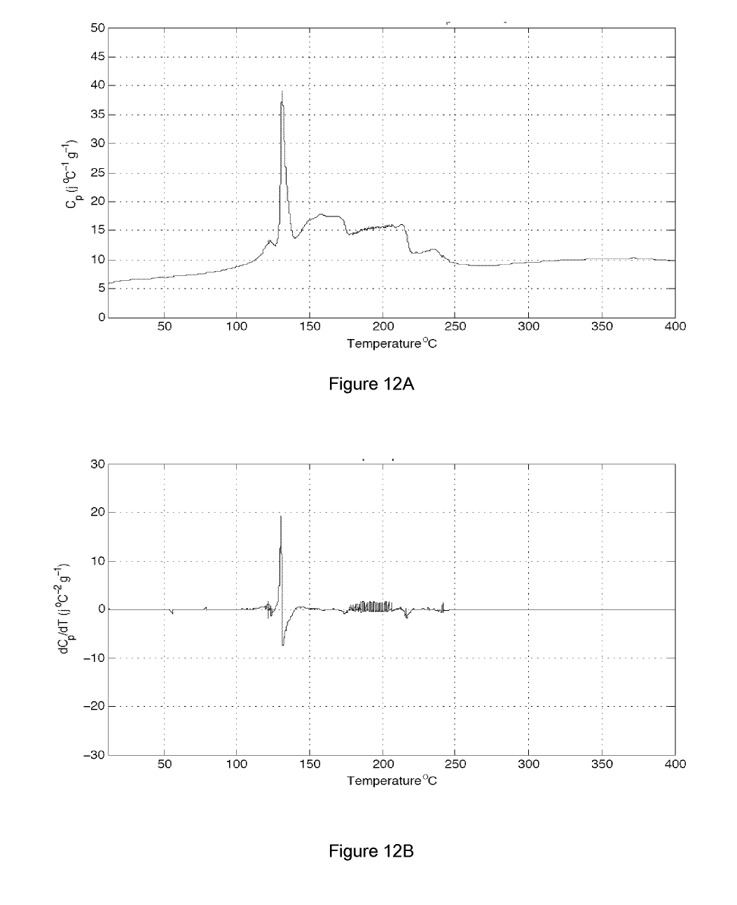

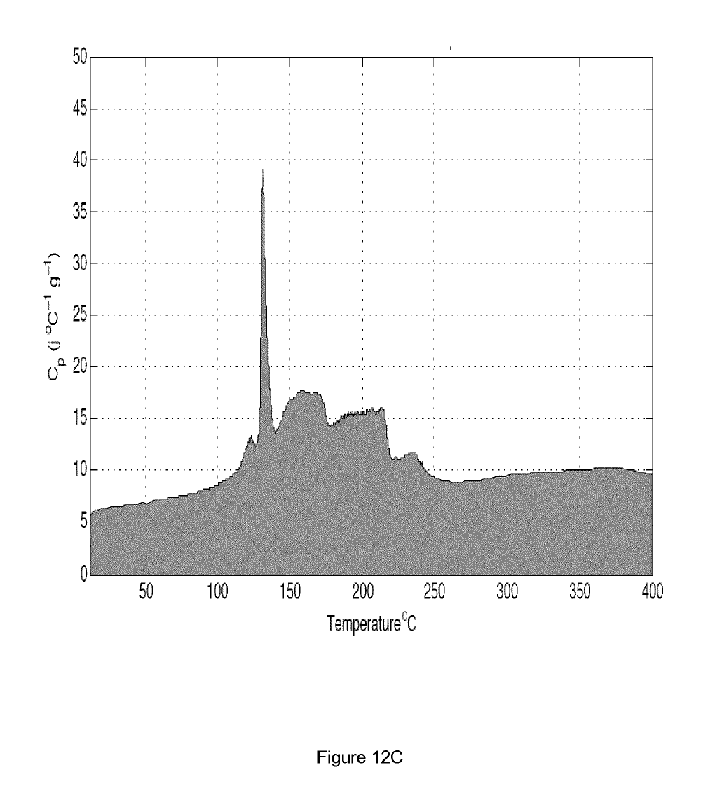

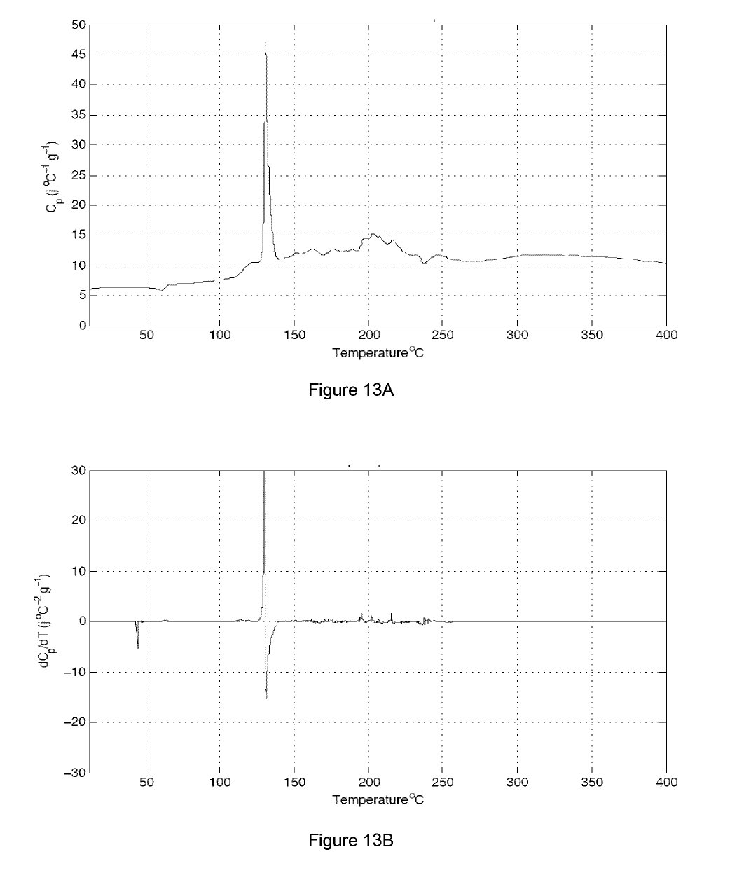

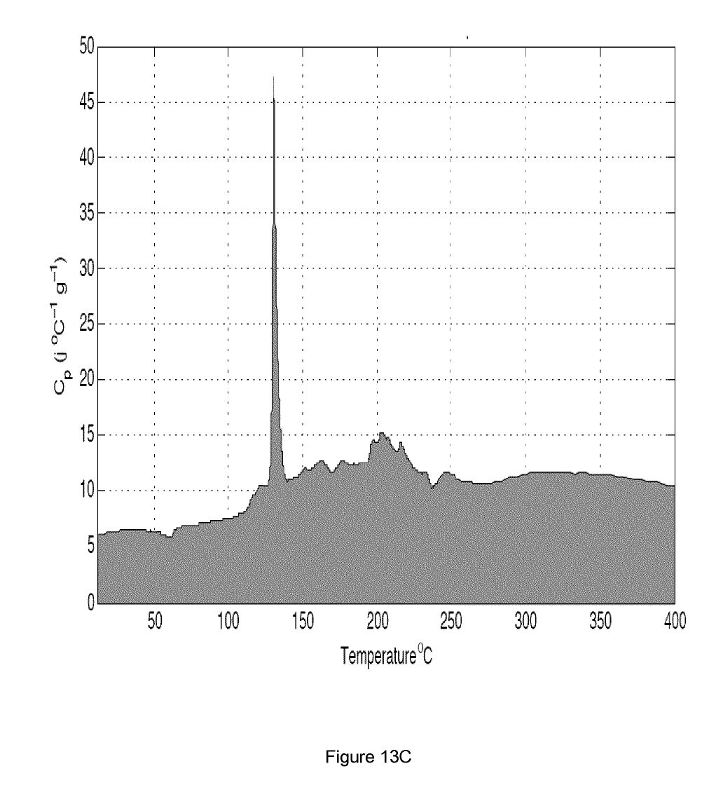

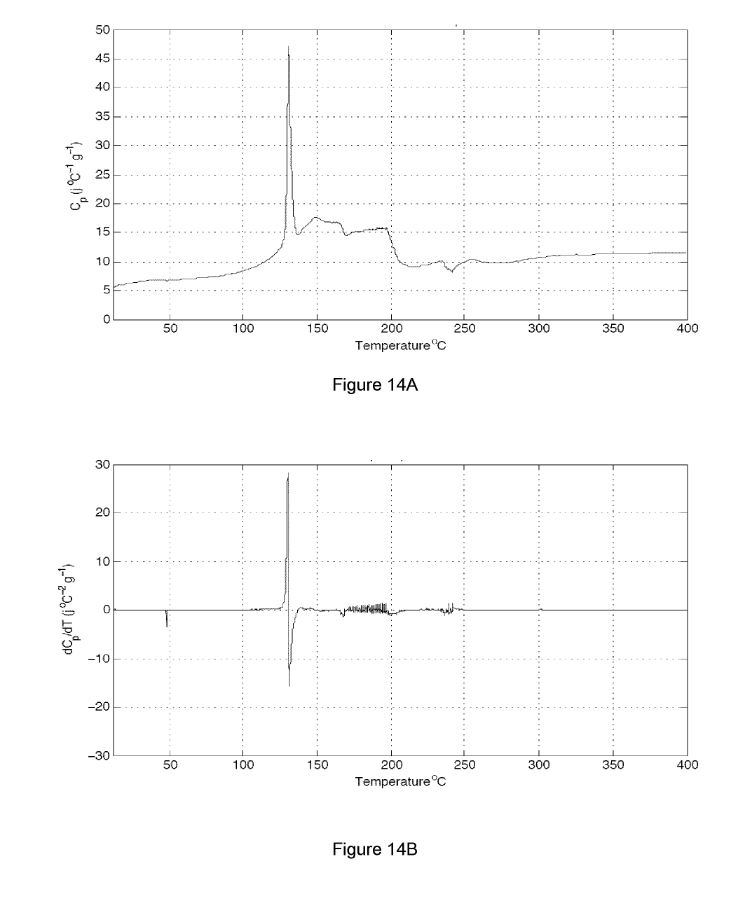

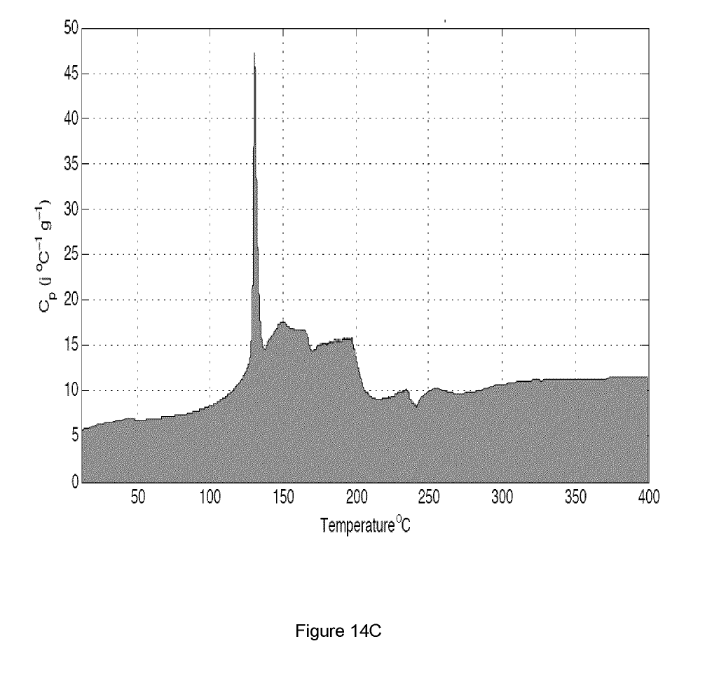

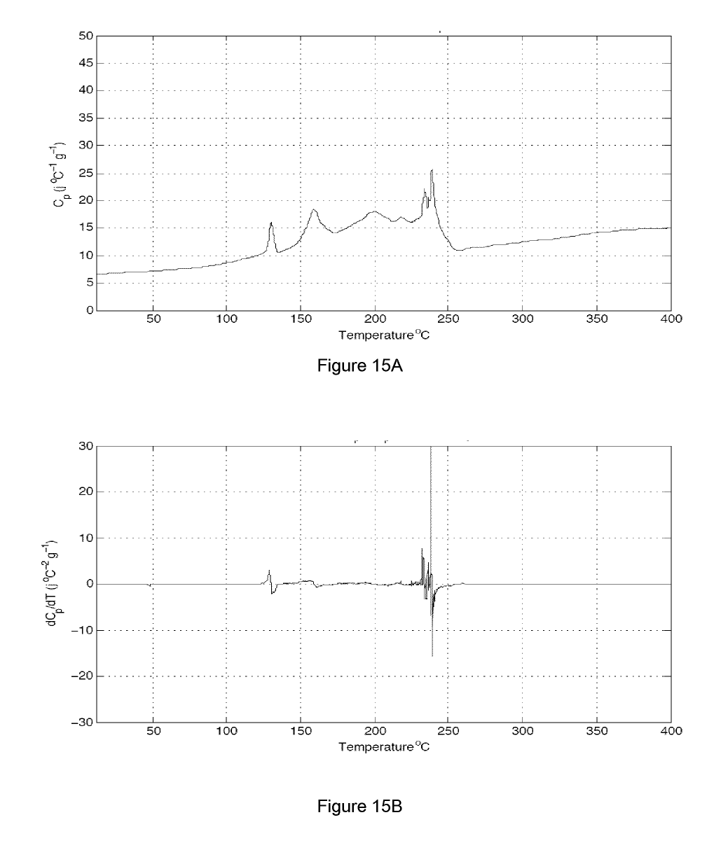

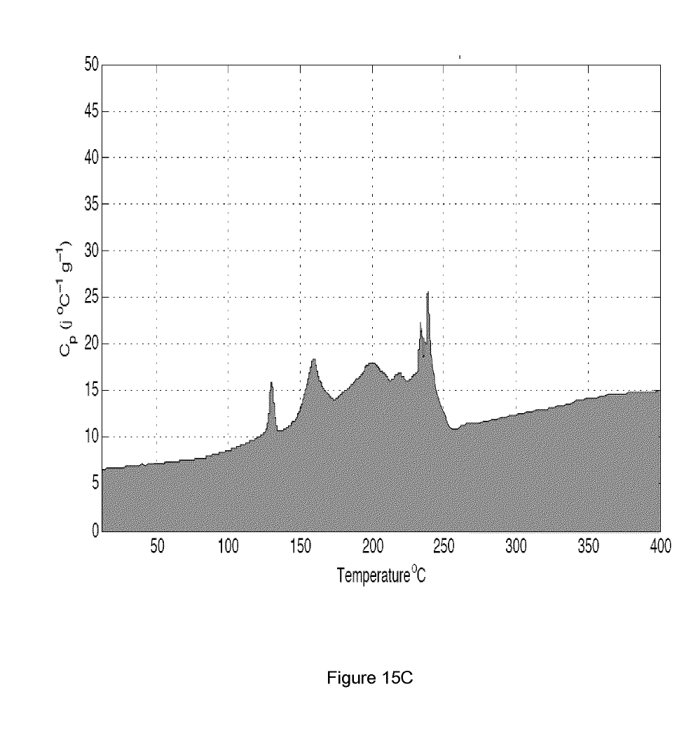

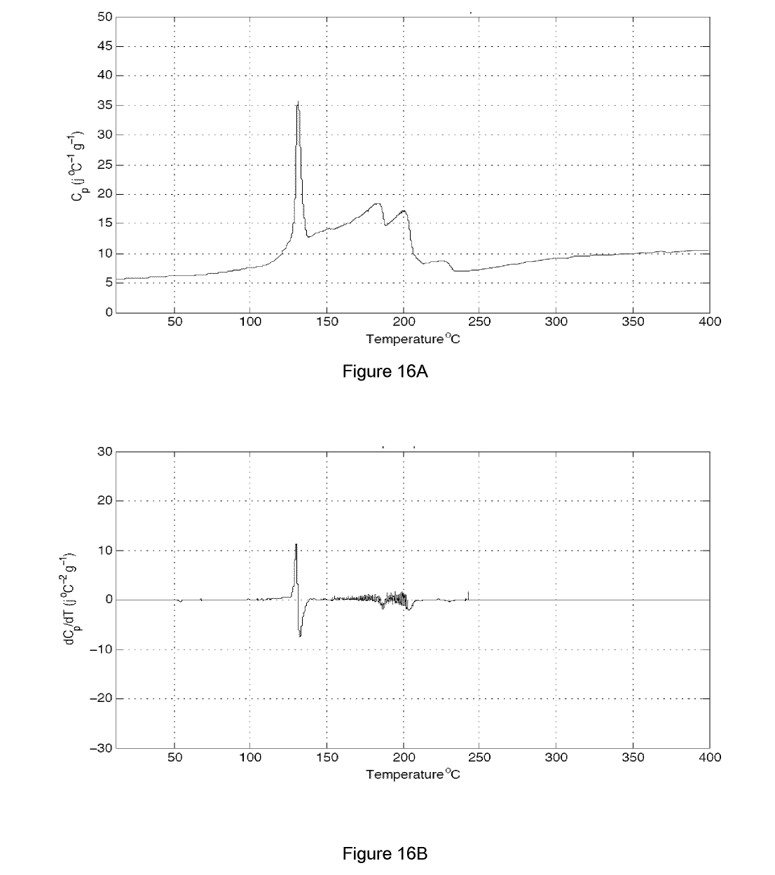

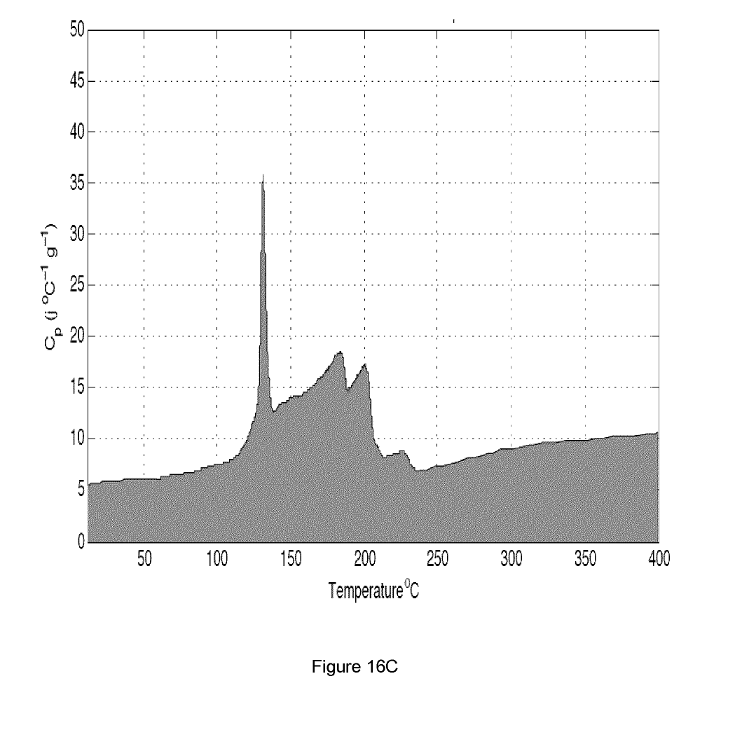

It will be appreciated that salts are not (or only negligibly) soluble in oils. Thus below the liquidus temperature(s) (phase transition) at least a portion of the salts will exist in solid or crystallized form. These salts “particles” exist in suspension in the oil (see FIG. 1 for a schematic representation) and their size will vary with temperature, especially in relation to the phase(s) transition(s) temperature(s), and the relative proportion of the salts in the mixture. When used in a heat exchange system the salts in the heat exchange fluid mixtures of the invention will typically be cycled between at least a partially solid state when below the phase(s) transition(s) temperature(s) and a liquid phase above that temperature(s). As the temperature is increased and approaches the liquidus (phase transition) temperature(s), the salts will start to melt and absorb large amount of heat until all salts are melted. Away from the phase transition(s) temperature(s) range, salts exhibit sensitive heat capacity characteristics which also contribute to the heat storage of the heat transfer fluid (see FIGS. 2-16).

The organic fluid (oil) part of the heat transfer fluid acts as a sensible heat storage material. Therefore as the temperature is raised the contribution of the SHS material to the total heat capacity manifest itself in a more or less linear fashion (no phase transition) although some oils may exhibit phase transitions but generally of smaller heat capacity variations than the salts.

The heat transfer fluids of the invention may further comprise heat conductivity enhancing particles (HCEP). In another aspect of the invention there is therefore provided ternary heat transfer fluids which comprise, in addition to the organic fluid and PCM, heat conductivity enhancing particles.

The heat conductivity enhancing particles are preferably selected from metals like Au, Al, Cu, Fe and the like. In some embodiments, the particles are selected from: silver oxide (AgO), titanium oxide (TiO₂), copper oxide (Cu₂O), aluminum oxide (Al₂O₃), germanium oxide (GeO), zirconium oxide (Zro₂), yttrium oxide (Y₂O₃), zinc oxide (ZnO), vanadium oxide (V₂O₅), indium oxide (InO), tin oxide (SnO), a doped and/or alloyed form thereof, and combinations thereof. However it will be appreciated that other conducting materials can be used such as ceramic for example.

The size of the HCEPs is preferably between 1 nm to 10 mm and more preferably between about 0.1 μm and 50 μm. The volume fraction of the particles in the ternary heat fluid is preferably between about 0.1% to 20%. It will be appreciated that the size and shape of the particles can influence their heat conductivity and as such these characteristics can be optimized depending of the desired heat transfer properties for the fluid.

It will be appreciated that the thermal behaviour of the heat transfer fluids of the invention may be complex. For example heat cycling of the mixtures may result in hysteresis. Therefore it may be desirable to condition a heat transfer fluid prior to its use for example by heat cycling the fluid through a range of temperatures encompassing the phase transition(s) (liquidus) temperatures without exceeding the temperature stability limit. Alternatively, in certain applications it may be desirable to take advantage of the hysteresis by using the fluid without conditioning.

The mixing of the different components of a heat transfer fluid of the invention should preferably be according to the following procedure: If more than one type of oil is used, the oils are first mixed together and then the heat conducting particles are added and mixed with the oil(s). The salts are grounded to a size of approximately 1 to 50 μm and mixed together if more than one salt is used.

The salts are then added to oil(s) or oil(s)/heat conducting particles and this final mixture is then stirred until a homogeneous texture is obtained. Optionally the salts, if moist, may be dried at a temperature of approximately 100° C. for several hours and preferably between 10 to 14 hours an then allowed to cool prior to grinding.

In another aspect of the invention there is provided a thermal storage and/or thermal energy transfer system comprising a heat transfer fluid of the present invention as described above. The thermal system may be concentrated solar power, wind turbines, compressed air energy storage (CAES) and the like. It will be appreciated that the physico-chemical characteristics of the heat transfer fluids of the invention can be optimized or selected with regards to the heat transfer unit design. By design it is meant for example characteristics of the system such as the diameter of the pipes used to carry the fluid, the pressure, the desired heat transfer response profile and the like.

The heat transfer fluid of the invention advantageously provides a composition in which the heat from a medium such as compressed air can be efficiently transferred to the PCM (salts) because the dispersion of the salts within the oil increase the uniformity of the heat distribution within the fluid enabling a more rapid and uniform heat storage within the most efficient heat storing component of the fluid, namely the PCM (salt). This is to be contrasted with a situation where only salts would be used in which case a gradient of temperature through the thickness of a salt volume resulting in a “delay” in the heat storage especially when the medium with which heat is exchanged has a relatively high velocity such as compressed air. This can appreciated from FIG. 1 where the flow of the heat transfer fluid of the invention in relation to the flow of compressed air is schematically represented. Without wishing to be bound by any theory, it can be seen that the oil will be in contact with the conduit wall carrying the flow of air and the heat will be propagated through the oil to the salts particles. This mode of heat exchange is not limited to heat exchange with air but would apply to any heat carrying media.

This illustrates the importance of the physico-chemical properties of the heat transfer fluid. According, it will be appreciated that thermodynamic values that characterize heat transfer fluids such as the total heat capacity within a certain temperature range (that can be obtained by integrating the area under the DSC curve in a range of temperatures: Int cₚ) may be sufficient to chose an appropriate heat transfer fluid for a particular heat exchange system. In a particular example where the heat transfer fluid would be used in a CAES system an Int cₚ of between 2 and 4×10³ J/g (table 23) between −50° C. and 300° C. irrespective of the actual relative proportion of the different components of the fluid would result in an optimized heat exchange efficiency.

The heat transfer fluids of the invention should also have a viscosity optimized for a particular heat transfer system. While it is possible to measure the viscosity experimentally it is also possible to use theoretical models such as the Krieger-Dougherty equation

$$μ = {{μ}_{s} ( 1 - \frac{ϕ}{{ϕ}_{m}} )}^{- 2.5 {ϕ}_{m}}$$

which correlates the viscosity of a suspension with that of a solution (μₛ) and the volume fraction of particles. Two key factors influence the viscosity of the suspension at a given volume fraction of the additives: the viscosity of the oil without additives and the intrinsic viscosity of the additives (the salts). Using this equation it was estimated that to have a heat transfer fluid with a viscosity of approximately less than 1000 cP the volume fraction of the salts and HCEP's should be less than approximately 60%.

The dynamic viscosity and kinematic viscosity are related by the density of the composition

μ=νρ

μ: dynamic viscosity, ν. kinematic viscosity, and ρ: density. In turn the density can be calculated by adding the density of each component weighed by it volume fraction in the composition. Alternatively the density can be measured experimentally.

In another aspect there is provided a method for storing heat energy whereby a heat is stored primarily in a PCM comprising suspending a PCM in an organic fluid such as oil to provide a heat transfer fluid, contacting the fluid with surface heated by a medium from which heat is to be transferred such that heat is conducted through the oil to the PCM for storage.

### EXAMPLES

Examples of heat transfer fluid mixtures are listed in tables 1 to 18. Table 1 provides examples of ranges for the different components of a heat transfer fluid composition of the invention. Table 2 provides examples of ranges for certain salts, table 3 provides a specific example of a mixture of salts (mixture M1). Tables 4 to 18 provide examples of specific heat transfer fluid compositions (heat transfer fluid Al to A8 and B1 to B7).

TABLE 1

| Global mixture | salts mixture | |
|---|---|---|
| Weight basis (g/g) | Weight basis g/g | components |
| 20-40% | 20-26% | Lithium nitrate |
| | 10-18% | Sodium nitrate |
| | 10-16% | Potassium nitrate |
| | 28-42% | Potassium nitrite |
| | 8-16% | Calcium nitrate |
| 55-70% | | Polymethyl Phenyl |
| | | Siloxane Fluid |
| 55-70% | | Synthetic Heat |
| | | Transfer Fluid |
| 5-15% | | copper particles |

TABLE 2
Example of percentage Mixture of salts

| | | Mass fraction |
|---|---|---|
| Salt type | Chemical formula | (g/g) |
| Lithium nitrate | LiNO3 | 20-36% |
| Sodium Nitrate | NaNO3 | 10-22% |
| Potassium nitrate | KNO3 | 42-58% |

TABLE 3
Mixture of salts used in experiments M1

| | | Mass fraction |
|---|---|---|
| Salt type | Chemical formula | (g/g) |
| Lithium nitrate | LiNO3 | 26% |
| Sodium Nitrate | NaNO3 | 18% |
| Potassium nitrate | KNO3 | 56% |

TABLE 4
A1

| Composition | Composition Type | Mass fraction |
|---|---|---|
| Oil (A) | Polymethyl phenyl siloxane | 70% |
| Salts | M1 | 25% |
| Metallic Particles | 0.5 μm copper | 5% |

TABLE 5
A2

| Composition | Composition Type | Mass fraction |
|---|---|---|
| Oil (A) | Polymethyl phenyl siloxane | 70% |
| Salts | M1 | 20% |
| Metallic Particles | 0.5 μm copper | 10% |

TABLE 6
A3

| Composition | Composition Type | Mass fraction |
|---|---|---|
| Oil (A) | Polymethyl phenyl siloxane | 65% |
| Salts | M1 | 25% |
| Metallic Particles | 0.5 μm copper | 10% |

TABLE 7
A4

| Composition | Composition Type | Mass fraction |
|---|---|---|
| Oil (A) | Polymethyl phenyl siloxane | 65% |
| Salts | M1 | 20% |
| Metallic Particles | 0.5 μm copper | 15% |

TABLE 8
A5

| Composition | Composition Type | Mass fraction |
|---|---|---|
| Oil (A) | Polymethyl phenyl siloxane | 60% |
| Salts | M1 | 25% |
| Metallic Particles | 0.5 μm copper | 15% |

TABLE 9
A6

| Composition | Composition Type | Mass fraction |
|---|---|---|
| Oil (A) | Polymethyl phenyl siloxane | 55% |
| Salts | M1 | 25% |
| Metallic Particles | 0.5 μm copper | 20% |

TABLE 10
A7

| Composition | Composition Type | Mass fraction |
|---|---|---|
| Oil (A) | Polymethyl phenyl siloxane | 65% |
| Salts | M1 | 25% |
| Metallic Particles | 10 μm copper | 10% |

TABLE 11
A8

| Composition | Composition Type | Mass fraction |
|---|---|---|
| Oil (A) | Polymethyl phenyl siloxane | 65% |
| Metallic Particles | 10 μm copper | 10% |

TABLE 12
B1

| Composition | Composition Type | Mass fraction |
|---|---|---|
| Oil (B) | Biphenyl and diphenyl oxide | 70% |
| Salts | M1 | 25% |
| Metallic Particles | 0.5 μm copper | 5% |

TABLE 13
B2

| Composition | Composition Type | Mass fraction |
|---|---|---|
| Oil (B) | Biphenyl and diphenyl oxide | 70% |
| Salts | M1 | 20% |
| Metallic Particles | 0.5 μm copper | 10% |

TABLE 14
B3

| Composition | Composition Type | Mass fraction |
|---|---|---|
| Oil (B) | Biphenyl and diphenyl oxide | 65% |
| Salts | M1 | 25% |
| Metallic Particles | 0.5 μm copper | 10% |

TABLE 15
B4

| Composition | Composition Type | Mass fraction |
|---|---|---|
| Oil (B) | Biphenyl and diphenyl oxide | 65% |
| Salts | M1 | 20% |
| Metallic Particles | 0.5 μm copper | 15% |

TABLE 16
B5

| Composition | Composition Type | Mass fraction |
|---|---|---|
| Oil (B) | Biphenyl and diphenyl oxide | 60% |
| Salts | M1 | 25% |
| Metallic Particles | 0.5 μm copper | 15% |

TABLE 17
B6

| Composition | Composition Type | Mass fraction |
|---|---|---|
| Oil (B) | Biphenyl and diphenyl oxide | 55% |
| Salts | M1 | 25% |
| Metallic Particles | 0.5 μm copper | 20% |

TABLE 18
B7

| Composition | Composition Type | Mass fraction |
|---|---|---|
| Oil (B) | Biphenyl and diphenyl oxide | 65% |
| Salts | M1 | 25% |
| Metallic Particles | 10 μm copper | 10% |

The heat transfer fluids of the invention comprising one or more organic fluids and one or more molten salts preferably possess the following physico-chemical characteristics: a dynamic viscosity between about 1.0 centipoise (cP) and 200 cP at temperatures from about -40° C. to about 400° C., a heat stability greater than about 200° C. with the heat stability reaching 400 to 700° C. with certain compositions. Certain physico-chamical properties of compositions of the invention are provided in tables 19-22.

TABLE 19

| | | density | density |
|---|---|---|---|
| | | g/cm³ | kg/m³ |
| Lithium Nitrate | LiNO3 | 2.38 | 2380 |
| Sodium Nitrate | NaNO3 | 2.26 | 2260 |
| Potassium Nitrate | KNO3 | 2.11 | 2110 |
| Salts Mixture | M1 | 2.2072 | 2207.2 |
| Copper | Cu | 8.96 | 8960 |
| Oil-A | Synthetic heat transfer | 1.102 | 1102 |
| | fluid (RJ-255, Hangzhou | | |
| | Chemical Co. ltd) | | |
| Oil-B | Biphenyl and diphenyl | 1.062 | 1062 |
| | oxide (RJ-790 Hangzhou | | |
| | Chemical Co. ltd) | | |

TABLE 20

| | Density g/cm³ | Density kg/m³ |
|---|---|---|
| A1 | 1.7712 | 1771.2 |
| A2 | 2.10884 | 2108.84 |
| A3 | 2.1641 | 2164.1 |
| A4 | 2.50174 | 2501.74 |
| A5 | 2.557 | 2557 |
| A6 | 2.9499 | 2949.9 |
| A7 | 2.1641 | 2164.1 |
| A8 | 1.7776 | 1777.6 |
| B1 | 1.7432 | 1743.2 |
| B2 | 2.08084 | 2080.84 |
| B3 | 2.1381 | 2138.1 |
| B4 | 2.47574 | 2475.74 |
| B5 | 2.533 | 2533 |
| B6 | 2.9279 | 2927.9 |
| B7 | 2.1381 | 2138.1 |

TABLE 21

| | | | | |
|---|---|---|---|---|
| | dynamic | dynamic | Density | kinematic |
| RPM | viscosity (cP) | viscosity (Pa · s) | (kg/m3) | viscosity (m2/s) |

A1

| | | | | |
|---|---|---|---|---|
| 20 | 124 | 0.124 | 1771.2 | 7.0009E−05 |
| 50 | 122 | 0.122 | 1771.2 | 6.88799E−05 |
| 100 | 133 | 0.133 | 1771.2 | 7.50903E−05 |

A2

| | | | | |
|---|---|---|---|---|
| 20 | 124 | 0.124 | 2108.84 | 5.88001E−05 |
| 50 | 126 | 0.126 | 2108.84 | 5.97485E−05 |
| 100 | 133 | 0.133 | 2108.84 | 6.30678E−05 |

A3

| | | | | |
|---|---|---|---|---|
| 20 | 124 | 0.124 | 2164.1 | 5.72986E−05 |
| 50 | 118 | 0.118 | 2164.1 | 5.45261E−05 |
| 100 | 128 | 0.128 | 2164.1 | 5.9147E−05 |

A4

| | | | | |
|---|---|---|---|---|
| 20 | 120 | 0.12 | 2501.74 | 4.79666E−05 |
| 50 | 118 | 0.118 | 2501.74 | 4.71672E−05 |
| 100 | 126 | 0.126 | 2501.74 | 5.03649E−05 |

A5

| | | | | |
|---|---|---|---|---|
| 20 | 112 | 0.112 | 2557 | 4.38013E−05 |
| 50 | 110 | 0.11 | 2557 | 4.30192E−05 |
| 100 | 116 | 0.116 | 2557 | 4.53657E−05 |

A6

| | | | | |
|---|---|---|---|---|
| 20 | 228 | 0.228 | 2949.9 | 7.72908E−05 |
| 50 | 192 | 0.192 | 2949.9 | 6.5087E−05 |
| 100 | 178 | 0.178 | 2949.9 | 6.0341E−05 |

A7

| | | | | |
|---|---|---|---|---|
| 20 | 208 | 0.208 | 2164.1 | 9.61139E−05 |
| 50 | 170 | 0.17 | 2164.1 | 7.85546E−05 |
| 100 | 165 | 0.165 | 2164.1 | 7.62442E−05 |

A8

| | | | | |
|---|---|---|---|---|
| 20 | 128 | 0.128 | 1777.6 | 7.20072E−05 |
| 50 | 123 | 0.123 | 1777.6 | 6.91944E−05 |
| 100 | 128 | 0.128 | 1777.6 | 7.20072E−05 |

TABLE 22

| | | | | |
|---|---|---|---|---|
| | dynamic | dynamic | Density | kinematic |
| RPM | viscosity (cP) | viscosity (Pa · s) | (kg/m3) | viscosity (m2/s) |

B1

| | | | | |
|---|---|---|---|---|
| 20 | — | | 1743.2 | — |
| 50 | 26 | 0.026 | 1743.2 | 1.49151E−05 |
| 100 | 26 | 0.026 | 1743.2 | 1.49151E−05 |

B2

| | | | | |
|---|---|---|---|---|
| 20 | 24 | 0.024 | 2080.84 | 1.15338E−05 |
| 50 | 27 | 0.027 | 2080.84 | 1.29755E−05 |
| 100 | 31 | 0.031 | 2080.84 | 1.48978E−05 |

B3

| | | | | |
|---|---|---|---|---|
| 20 | — | | | |
| 50 | 22 | 0.022 | 2138.1 | 1.02895E−05 |
| 100 | 28 | 0.028 | 2138.1 | 1.30957E−05 |

B4

| | | | | |
|---|---|---|---|---|
| 20 | 24 | 0.024 | 2475.74 | 9.69407E−06 |
| 50 | 30 | 0.03 | 2475.74 | 1.21176E−05 |
| 100 | 33 | 0.033 | 2475.74 | 1.33293E−05 |

B5

| | | | | |
|---|---|---|---|---|
| 20 | 24 | 0.024 | 2533 | 9.47493E−06 |
| 50 | 26 | 0.026 | 2533 | 1.02645E−05 |
| 100 | 30 | 0.03 | 2533 | 1.18437E−05 |

B6

| | | | | |
|---|---|---|---|---|
| 20 | 24 | 0.024 | 2927.9 | 8.197E−06 |
| 50 | 26 | 0.026 | 2927.9 | 8.88008E−06 |
| 100 | 33 | 0.033 | 2927.9 | 1.12709E−05 |

B7

| | | | | |
|---|---|---|---|---|
| 20 | 20 | 0.02 | 2138.1 | 9.3541E−06 |
| 50 | 24 | 0.024 | 2138.1 | 1.12249E−05 |
| 100 | 28 | 0.028 | 2138.1 | 1.30957E−05 |

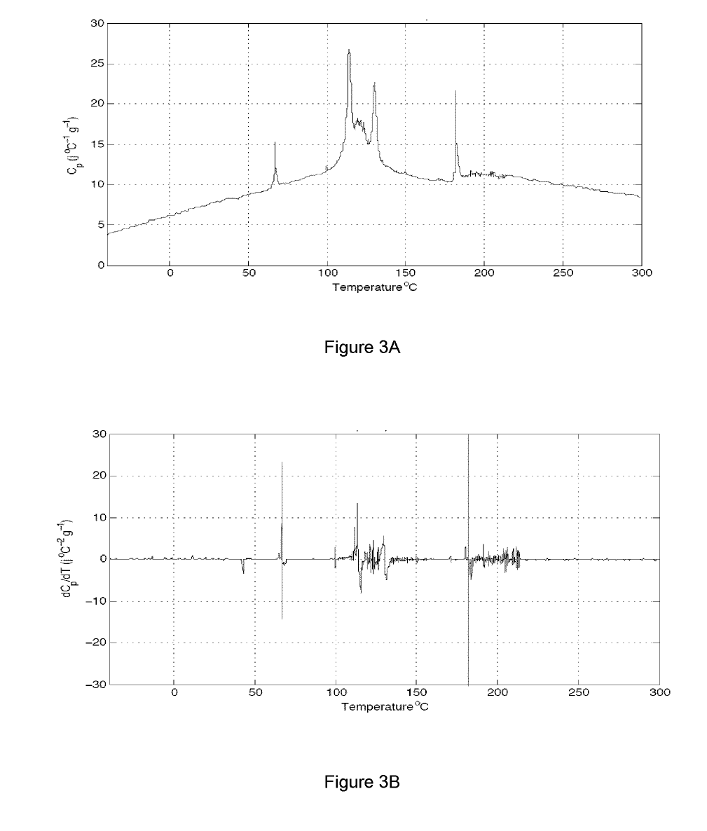

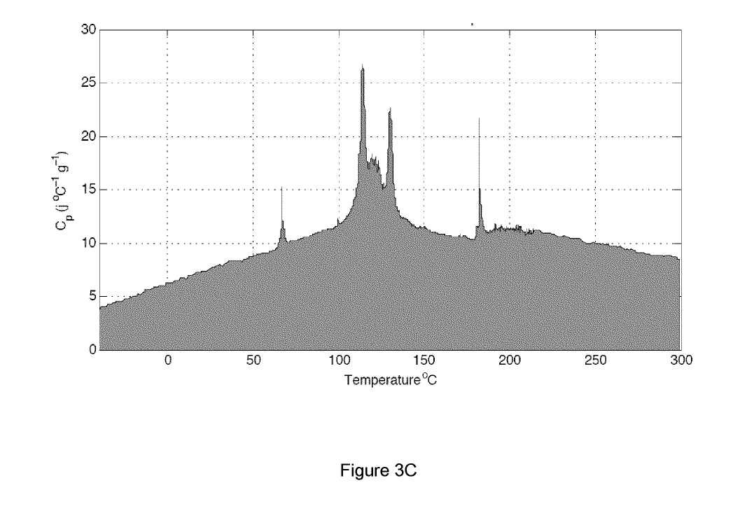

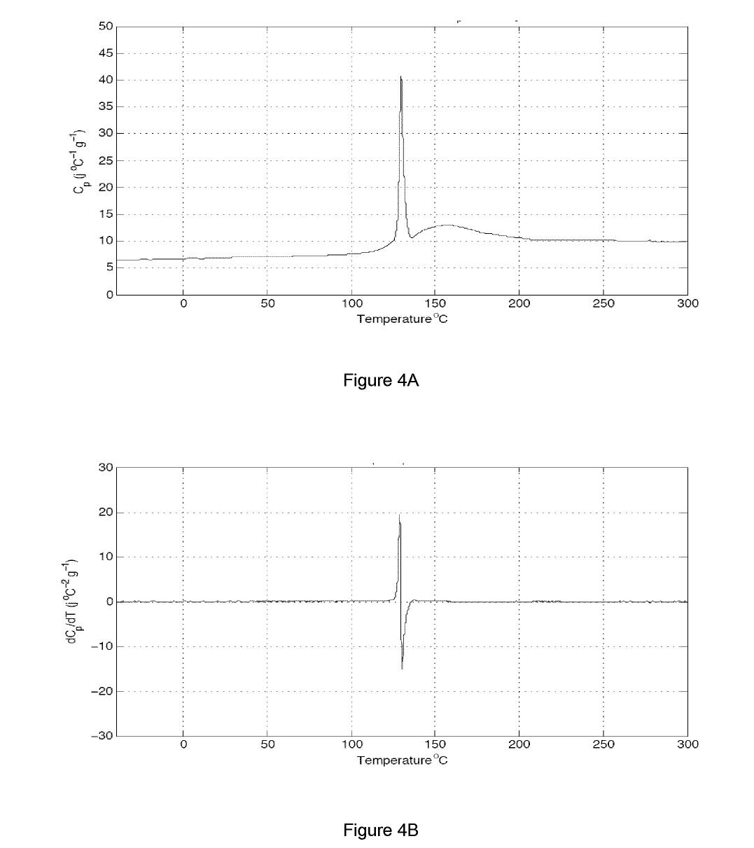

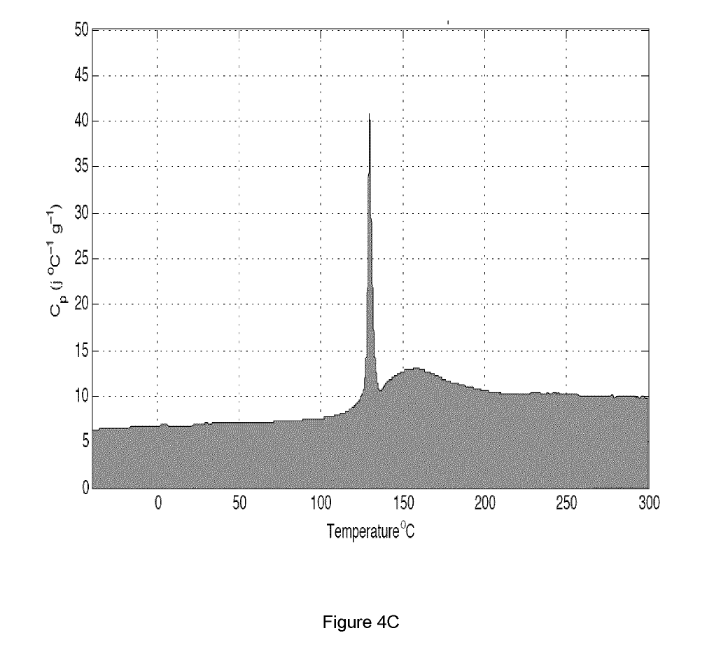

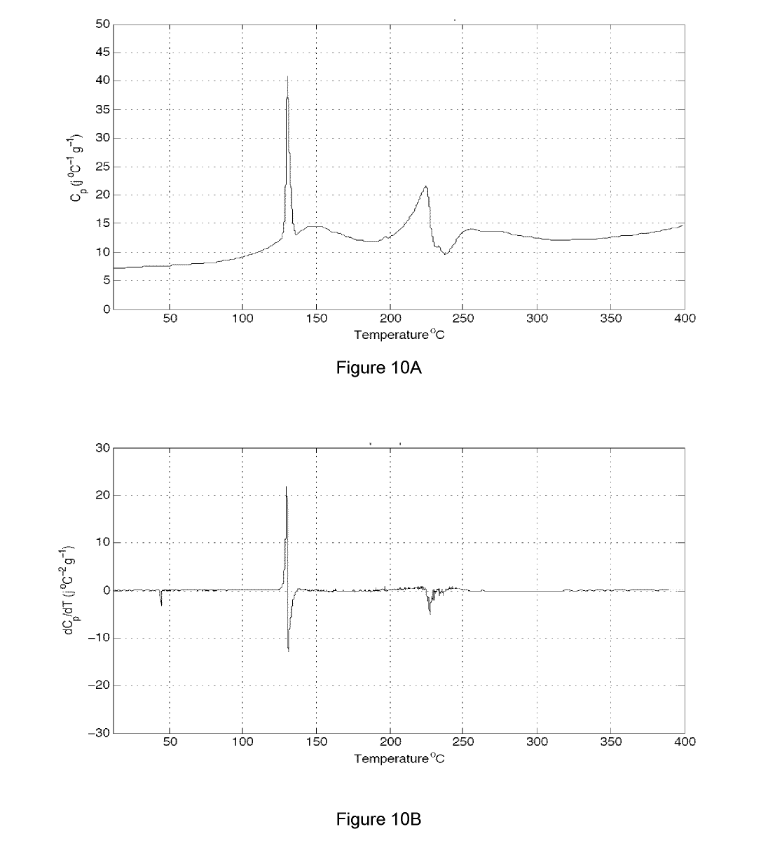

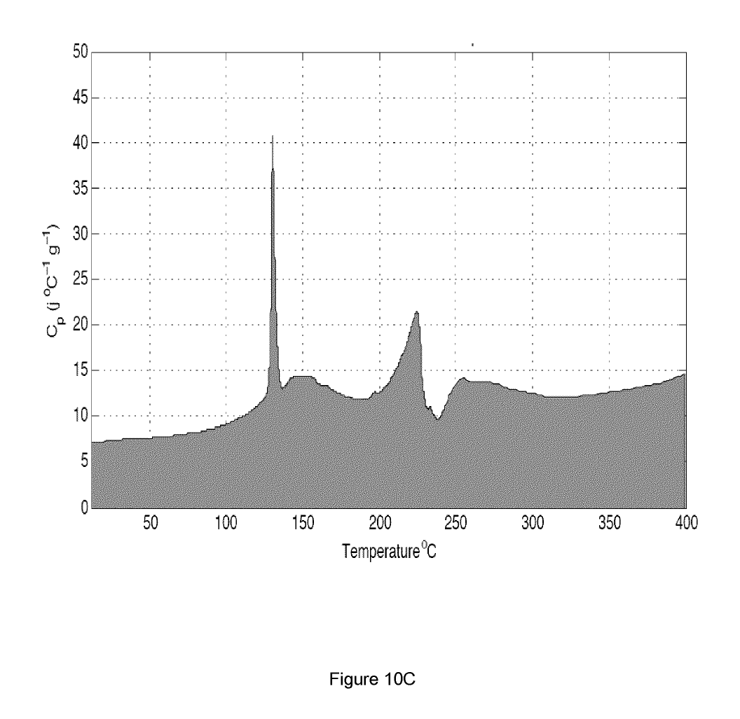

Differential scanning calorimetry curves for compositions A1-A8 and B1-B7 are shown in FIGS. 2 to 16 along with the derivative curves and curves showing the area under the curves. For example in FIG. 2A two transitions are clearly visible, one sharp transition at around 130° C. and one broader one between about 150 and 200° C. A similar curve is observed for the composition of FIG. 4A. However, the composition of FIG. 3A exhibits a more complex phase transitions pattern with sharp transitions at about 75° C, 115° C., 130° C. and 175° C. and a broader poorly defined underlying transition. In general it will be appreciated that by changing the nature of the organic fluid but keeping the other components of the composition the same the thermal behaviour of the compositions are different. For example mixture Al comprises polymethyl phenyl siloxane oil and B1 comprises a biphenyl and diphenyl oxide oil and their thermal behaviour are very different (FIG. 2A and 10A respectively). This is true for the other mixtures as well in which only the oil component has been modified. As can be seen from these example it is possible to select a heat transfer fluid that enables heat storage of a pre-determined quantity in a range of temperature that can be selected to optimize heat storage and transfer in a particular heat transfer system. For example if a particular heat transfer system requires a heat capacity “surge” between 200 and 250° C. composition B2 would better suit this need than composition A2 even though they have the same salt mixtures.

The range of temperatures over which the DSC curves were obtained are representative of the useful range for these compositions which is approximately from −40° C. to 300° C. for the polymethyl phenyl siloxane oil (compositions A's) and approximately from 10 to 400° C. for the biphenyl diphenyl oxide oil (compositions B's). It will be appreciated that compositions that comprise more than one salt can exhibit multiple phase transition temperatures (multiple liquidus temperatures). Also it is possible that certain salt mixtures exhibit eutectic behaviour, that is to say exhibiting a single phase transition for a specific molar ratio of salts. The phase transition temperatures are important to consider in the overall design of a heat exchange system. By this it is meant that because every heat exchange system will exhibit different temperature profiles (temperature distribution within the system) optimization of the heat transfer and storage will depend on the phase state of the heat transfer fluid.

The total heat capacity Cp of the heat transfer fluids of the invention over a range of temperature is the combination of the sensible heat capacity the phase change enthalpy. Different compositions will exhibit different total Cp furthermore the cumulative Cp as a function of temperature also varies as a function of the composition of the mixtures as can be seen from the DSC curves. Tables 23 and 24 provides integrated values of Cp over the range of temperatures used for obtaining the DSC curves for compositions A1-A8 and B1-B7.

TABLE 23

| Mixture | Int_{Cp} | [T1, T2](° C.) |
|---|---|---|
| A1 | 3.2706e+03 | [−40, 300] |
| A2 | 3.3923e+03 | [−40, 300] |
| A3 | 3.1503e+03 | [−40, 300] |
| A4 | 2.6767e+03 | [−40, 300] |
| A5 | 2.5199e+03 | [−40, 300] |
| A6 | 3.2127e+03 | [−40, 300] |
| A7 | 3.7889e+03 | [−40, 300] |
| A8 | 2.3516e+03 | [−40, 300] |
| B1 | 4.6730e+03 | [12, 400] |
| B2 | 4.5269e+03 | [12, 400] |
| B3 | 4.2280e+03 | [12, 400] |
| B4 | 4.1480e+03 | [12, 400] |
| B5 | 4.2323e+03 | [12, 400] |
| B6 | 4.8072e+03 | [12, 400] |
| B7 | 3.8354e+03 | [12, 400] |

TABLE 24

| Mixture | Int_{Cp} | [T1, T2] (° C.) |
|---|---|---|
| A1 | 2.93E+03 | [12, 300] |
| A2 | 3.11E+03 | [12, 300] |
| A3 | 2.81E+03 | [12, 300] |
| A4 | 2.35E+03 | [12, 300] |
| A5 | 2.23E+03 | [12, 300] |
| A6 | 2.88E+03 | [12, 300] |
| A7 | 3.34E+03 | [12, 300] |
| A8 | 2.07E+03 | [12, 300] |
| B1 | 3.39E+03 | [12, 300] |
| B2 | 3.55E+03 | [12, 300] |
| B3 | 3.23E+03 | [12, 300] |
| B4 | 3.01E+03 | [12, 300] |
| B5 | 3.11E+03 | [12, 300] |
| B6 | 3.42E+03 | [12, 300] |
| B7 | 2.84E+03 | [12, 300] |

Settling/Precipitation

The phase change material and any heat conducting particles can be stable in suspension for a sufficiently long period to be used without an agitator or circulation. It has been found that particle sizes from about 0.1 μm to about 10 μm the organic fluids mentioned above can remain in suspension for more than a week without settling or separation. The tolerable particle size and the time that the system remains in suspension can depend on the organic fluid's viscosity and other properties. The heat conducting particles, for example copper, can separate and be re-homogenized into the fluid with more difficulty than some salts.

When the particle size is greater than 10 μm, it has been found that the settling time is sufficiently short that agitation can be required to maintain the suspension, however, with agitation, the fluid can be very useful up to particle sizes of about 25 μm, after which the agitation effort can become challenging.

The heat storage system can include a circulation pump, stirring device or the like within or in association with the storage vessel or storage vessels for the heat transfer fluid. The agitator can thus maintaining the phase change material and any heat conducting particles in suspension for any length of time, and can also allow larger particle sizes, for example from about 10 μm to about 25 μm to be used, even if particle sizes between about 0.1 μm to about 10 μm may be chosen as a preferred size to have suspension stability even in temporary absence of agitation.

What is claimed is:

1. A heat transfer fluid comprising one or more phase change material (PCM) and one or more organic fluid, wherein the one or more PCM is a molten salt, and the one or more organic fluid is an oil.

2. The heat transfer of claim 1 wherein the molten salt is in suspension in the oil.

3. The heat transfer fluid of claim 1 wherein the heat transfer fluid has at least one liquidus temperature (phase transition) of less than about 25000.

4. The heat transfer fluid of claim 1 wherein the heat transfer fluid has a threshold of thermal stability greater than 200° C.

5. The heat transfer fluid of claim 1 wherein the heat transfer fluid has a viscosity of about 1 cP to about 400 cP.

6. The heat transfer fluid of claim 1 wherein the organic fluid is selected from synthetic oil and silicone oil.

7. The heat transfer fluid of claim 6 wherein the synthetic oil is selected from biphenyl, diphenyl oxide and combination thereof.

8. The heat transfer fluid of claim 6 wherein the silicone oil is polymethoxy phenyl siloxane.

9. The heat transfer fluid of claim 1 having a molar composition of about 20% to about 40% of the molten salt and about 50% to about 80% of the oil.

10. The heat transfer fluid of claim 1 wherein the molten salt is selected from nitric acid salt, nitric oxide salt and combination thereof.

11. The heat transfer fluid claim 10 wherein the molten salt or molten salt combination is selected from K, Na, Li, Ca-nitrate salts, K, Na, Li, Ca nitrite salts and combination thereof.

12. The heat transfer fluid of claim 11 wherein the molten salt is a combination of NaNO3, KNO3, and LiNO3.

13. The heat transfer fluid of claim 12 wherein the combination has a molar composition of about 10-22% NaNO₃, about 42-58% KNO₃, and about 20-36% LiNO₃.

14. The heat transfer fluid of claim 1, wherein the molten salts have a particle size of /from about 0.1 to about 50 μm.

15. The heat transfer fluid of claim 14, wherein the molten salts have a particle size of from about 0.1 to about 25 μm.

16. The heat transfer fluid of claim 1 wherein the molten salts have at least one phase transition of less than about 150° C.

17. The heat transfer fluid of claim 1 having a heat capacity of between about 2 and 4×10³ j/g between −40° C. and 300° C.

18. The heat transfer fluid of claim 1 further comprising heat conductivity enhancing particles.

19. The heat transfer fluid of claim 18 having a molar composition of about 20% to about 40% of the molten salt, about 50% to about 80% of the oil and about 1% to about 20% of the heat conductivity enhancing particles.

20. The heat transfer fluid of claim 18 wherein the heat conducting particles have a size of about 0.1 μm to about 50 μm.

21. The heat transfer fluid of claim 20, wherein the heat conducting particles have a size of about 0.1 μm to about 25 μm.

22. The heat transfer fluid of claim 1, wherein the phase change material and any heat conducting particles are stable in suspension without agitation for a period of at least 24 hours.

23. An energy storing system comprising a heat transfer fluid as claimed in claim 1.

24. The system of claim 23 which is a CAES system.

25. The system of claim 23, further comprising at least one storage vessel for said fluid and an agitator for maintaining the phase change material and any heat conducting particles are stable in suspension.
